(19) United States
(12) Patent Application Publication
(10) Pub. No.: US 2008/0240892 A1
(43) Pub. Date: Oct. 2, 2008

(54) STORAGE BUFFER DEVICE FOR AUTOMATED MATERIAL HANDLING SYSTEMS

(75) Inventors: Louise C. Courtois, Hopewell Junction, NY (US); Jeffrey P. Gifford, Fishkill, NY (US); David J. Pinckney, Newtown, CT (US); Uldis A. Ziemins, Poughkeepsie, NY (US)

Correspondence Address: CANTOR COLBURN LLP - IBM FISHKILL, 20 Church Street, 22nd Floor, Hartford, CT, 06103, US

(73) Assignee: International Business Machines Corporation, Armonk, NY (US)

(21) Appl. No.: 11/692,226

(22) Filed: Mar. 28, 2007

(51) Int. Cl. B65G 49/07

(52) U.S. Cl. 414/225.01

(57) ABSTRACT

A storage buffer system for an automated material handling system (AMHS) includes a retractable buffer device disposed in proximity to a processing tool, the retractable buffer device having an extended position disposed directly below an overhead transport (OHT) vehicle path. The retractable buffer device further includes a retracted position that is removed from a process aisle space. In the extended position, the retractable buffer device is configured to facilitate loading and unloading of product therein without the use of lateral motion capability of an OHT vehicle.

### BACKGROUND

The present invention relates generally to automated material handling systems (AMHS), and, more particularly, to an improved storage buffer device for AMHS, such as those used in semiconductor fabrication facilities, for faster material exchange.

Integrated circuit (IC) devices are manufactured by performing a number of various processing steps on a semiconductor wafer or substrate in a semiconductor fabrication facility (commonly referred to as a “fab” in the art). In a fab, wafers are normally held in a central store (commonly referred to as a “stocker”), and are transported to one or more processing stations. During transportation, a number of wafers are held in individual boxes, such as standard mechanical interface (SMIF) pods, or front opening unified pods (FOUPs). Such containers may also be generally referred to as “carriers,” “cassettes,” or “boxes.” The size of a carrier depends upon the wafer diameter and the maximum number of wafers that may be held therein, and have been known to contain anywhere from a single wafer to about 25 wafers.

FIG. 1 is a perspective view of an exemplary fab 100 known in the art. As is shown, a carrier 102 may be picked up from a stocker 104 by an overhead transport vehicle (“OHV” or “OHT”) 106, and transported along a rail, track or series of tracks 108 to any of a number of processing stations 110 (also called “processing systems” or “process tools”), depending on the specific fabrication steps that are to be performed thereon. In lieu of an OHV 106, carriers 102 may also be carried manually, or alternatively by an automated guided vehicle (AGV), a personal guided vehicle (PGV) or by a floor-installed rail guided vehicle (RGV). After transport, each carrier 102 is placed on a load port 112 (also referred to as a “box opener”) so that the wafers contained therein may be extracted by a robot (not shown) located within a near particle-free environmental enclosure of the associated processing station 110, in which the wafers may be handled. Alternatively, the processing station 110 may transfer the entire carrier to an internal storage shelf within for future processing.

Depending on the throughput of the various processing stations 110, as well as the order in which the stations are used during fabrication, different numbers of load ports (e.g., 1, 2, 4, etc.) may be provided for a given processing station. The exemplary fab 100 depicts three processing stations 100 with 2 load ports and one processing station 100 with 4 load ports. Each load port 112 is capable of supporting a single carrier 102.

As is the case with other automated fabrication industries, the semiconductor industry continuously searches for ways to increase wafer output and/or reduce overall equipment costs. Included among the factors that significantly affect the overall cost for a given piece of equipment are clean room costs, tool footprint (area) and labor costs. It is well recognized that overall fab productivity is increased by ensuring a constant supply of wafers at each tool so as to minimize product delivery delay, maximize throughput and reduce tool idle time. One way to accomplish this is to provide a local buffer supply of wafers at each tool, preferably as close to the load ports of the tool as practically possible.

One conventional approach to providing a local stocking/buffering system is to locate a buffer structure upstream from a process tool, which is mounted from the fab ceiling and is disposed within the process aisle itself (i.e., along the path of the OHV). This type of buffering system is also referred to as “under track buffering” (UTB), an example of which is illustrated in FIG. 2. As is shown in the top down view of FIG. 2, the UTB system 200 includes a buffer location 202 disposed between neighboring process tools 110, but directly beneath the OHT (i.e., directly below the vehicle 106 and track 108). Although UTB systems are compatible with simpler hoist mechanisms (i.e., vertical hoist motion only), being located directly below the path of the transport vehicle 106), the buffer locations 202 are located within the process aisle and must be suspended low enough so that the vehicle and hoist mechanism have sufficient clearance to pass above. As such, this decreases the available headroom in the process aisle at the UTB locations. Moreover, such UTB locations may need to be removed during the installation of larger process tools.

Another local buffer approach is what is referred to as “side track buffering” (STB), an example of which is illustrated in FIG. 3. Whereas the UTB buffer locations are directly beneath the OHT path, the buffer locations of the STB system 300 in FIG. 3 are located adjacent to the OHT tracks 108. Like the UTB buffers, the STB buffers 302 are typically suspended from the ceiling in the process aisle. However, since they are not located directly in the path of the OHT vehicle, they do not need to be suspended lower than the vehicle's hoist for clearance purposes. Thus, process aisle headroom is not an issue with STB systems. On the other hand, since the buffers 302 are located adjacent to the vehicle paths, the vehicle hoist must be capable of lateral motion (e.g., through retractable arm 304) in order to store/retrieve the carriers 102 from the buffer locations. Such OHT vehicles are inherently more specialized and complex than simple vertical motion vehicles.

Further, in both UTB and STB systems, the storage locations are upstream with respect to a neighboring tool, which still inherently results in some product delivery delay. Accordingly, a need exists for a local material buffer system that provides further improvement with respect to product delivery delay, that does not take up additional floor space or intrude on the process aisle headroom, and that is also compatible with existing, less complex OHT hardware.

### SUMMARY

The foregoing discussed drawbacks and deficiencies of the prior art are overcome or alleviated, in an exemplary embodiment, by a storage buffer system for an automated material handling system (AMHS), including a retractable buffer device disposed in proximity to a processing tool, the retractable buffer device having an extended position disposed directly below an overhead transport (OHT) vehicle path; and the retractable buffer device further having a retracted position that is removed from a process aisle space; wherein, in the extended position, the retractable buffer device is configured to facilitate loading and unloading of product without the use of lateral motion capability of an OHT vehicle.

In another embodiment, a storage buffer system for semiconductor manufacturing facility includes a retractable buffer device disposed in proximity to a load port of a processing tool; the retractable buffer device having an extended position disposed directly below an overhead transport (OHT) vehicle path; and the retractable buffer device further having a retracted position that is removed from a process aisle space; wherein, in the extended position, the retractable buffer device is configured to facilitate loading and unloading of one or more wafer carriers without the use of lateral motion capability of an OHT vehicle.

In still another embodiment, a method of implementing buffer storage in an automated material handling system (AMHS) includes moving a retractable buffer device, disposed in proximity to a processing tool, to an extended position disposed directly below an overhead transport (OHT) vehicle path; loading the retractable buffer device with a carrier, through vertical motion of a hoist mechanism associated with a first OHT vehicle, and without the use of lateral motion capability of the first OHT vehicle; and moving the retractable buffer to a retracted position that is removed from a process aisle space.

### BRIEF DESCRIPTION OF THE DRAWINGS

Referring to the exemplary drawings wherein like elements are numbered alike in the several Figures:

FIG. 1 is a perspective view of an exemplary semiconductor fabrication facility (fab) known in the art;

FIG. 2 is a top down view of an existing under track buffering (UTB) system for a fab;

FIG. 3 is a top down view of an existing side track buffering (UTB) system for a fab; and

FIGS. 4(a) through 4(n) are schematic diagrams of a retractable storage buffer system for fabs, in accordance with an embodiment of the invention.

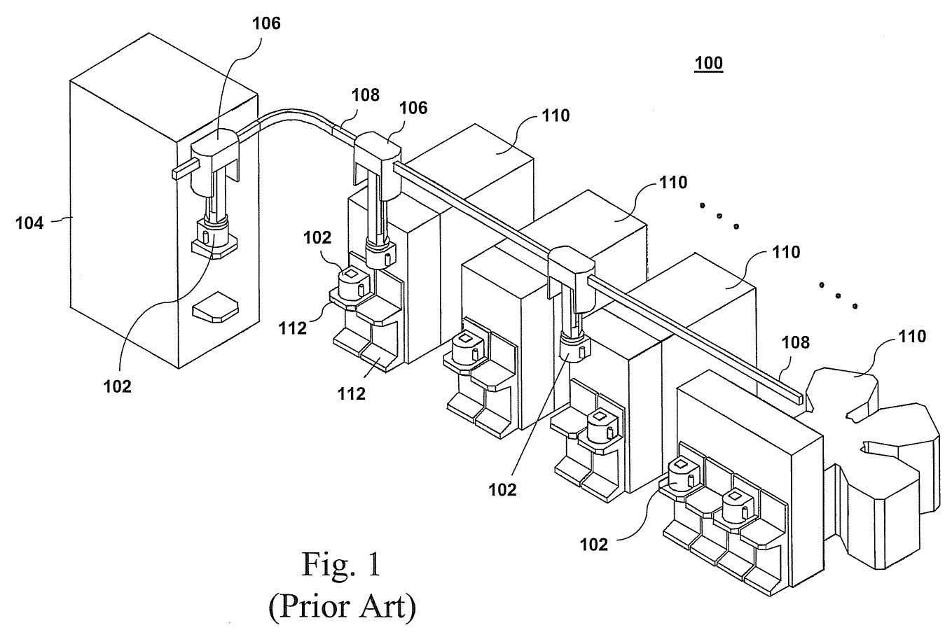

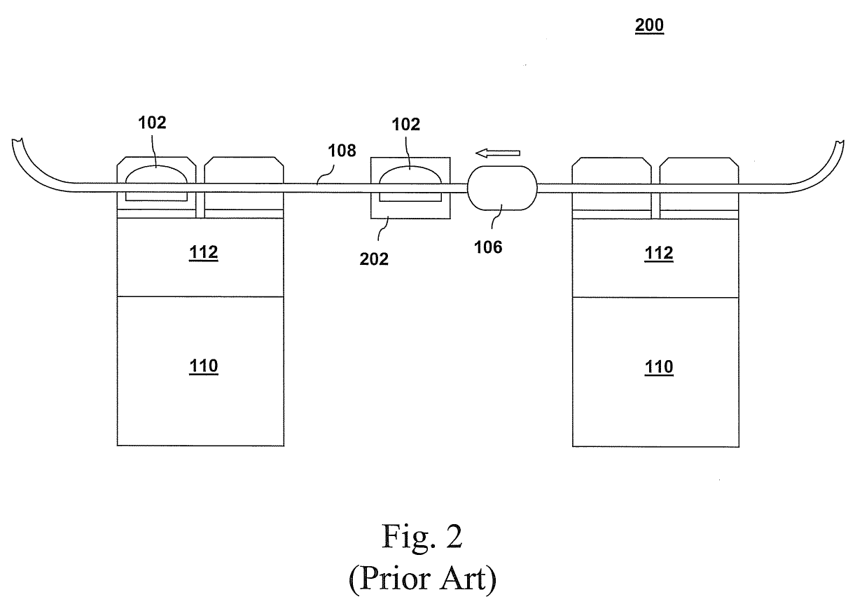

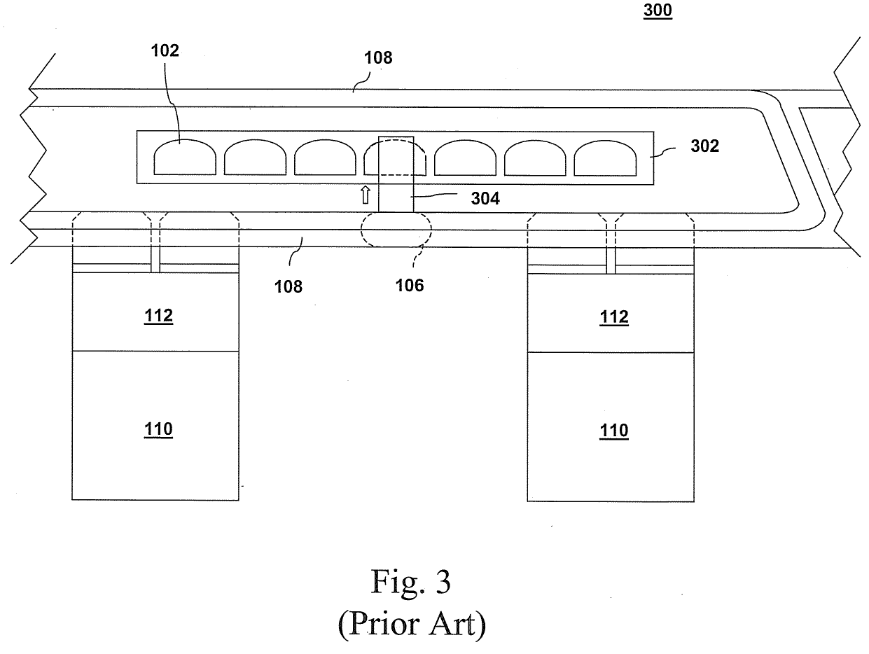

### DETAILED DESCRIPTION

Disclosed herein is an improved product storage/buffering system for AMHS facilities, such as semiconductor fabs. Briefly stated, a retractable buffer device is configured directly above (or in close proximity to) a process tool load port. In an extended position, the retractable buffer device is located directly below the path of an OHT vehicle for simple, vertical storage or retrieval of a carrier/FOUP. Once a FOUP is placed into the buffer (or removed therefrom), the buffer device may be withdrawn to a retracted position such that it does not remain within the process aisle but still remains closer to the processing tool with respect to a conventional “upstream” buffer.

Thus configured, the retractable buffer device (referred to hereinafter as a “side slide buffer” or SSB) minimizes product exchange time by positioning the next product to be processed in close proximity to the tool load port. Moreover, the SSB is compatible with existing, simpler OHT vehicles that provide only vertical hoist motion and do not require more complex OHT vehicles with lateral arm motion. Further, in a retracted position, the SSB does not restrict the headroom space in the process aisle and does not interfere with process tool installations. Rather, the SSB offers installation flexibility and provides additional, local tool support buffering without adding the cost of (or requiring the space for) an additional, conventional load port.

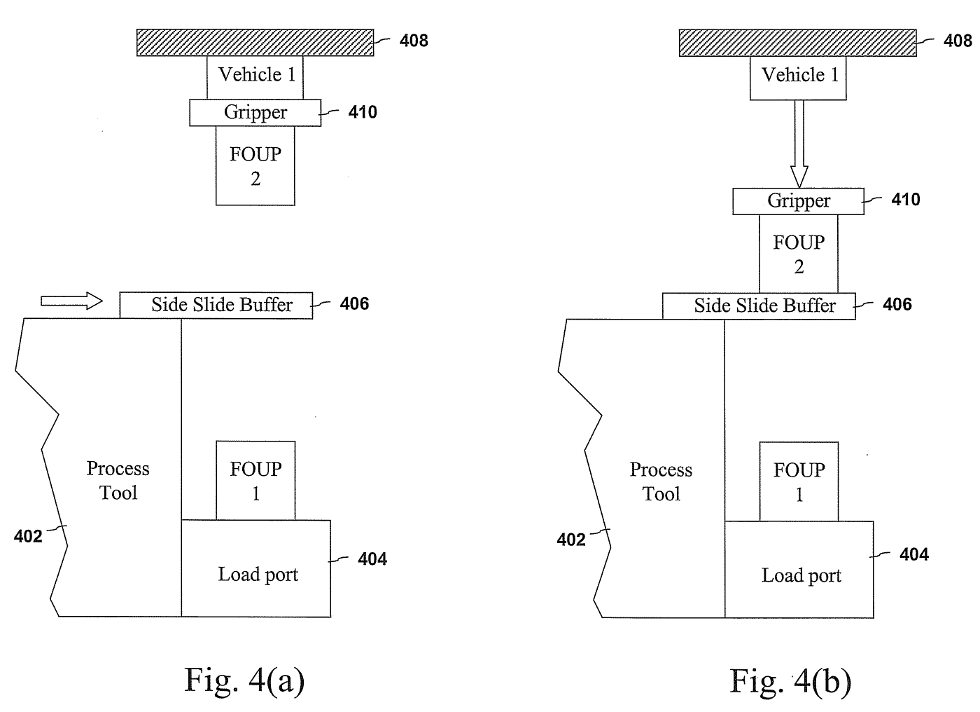

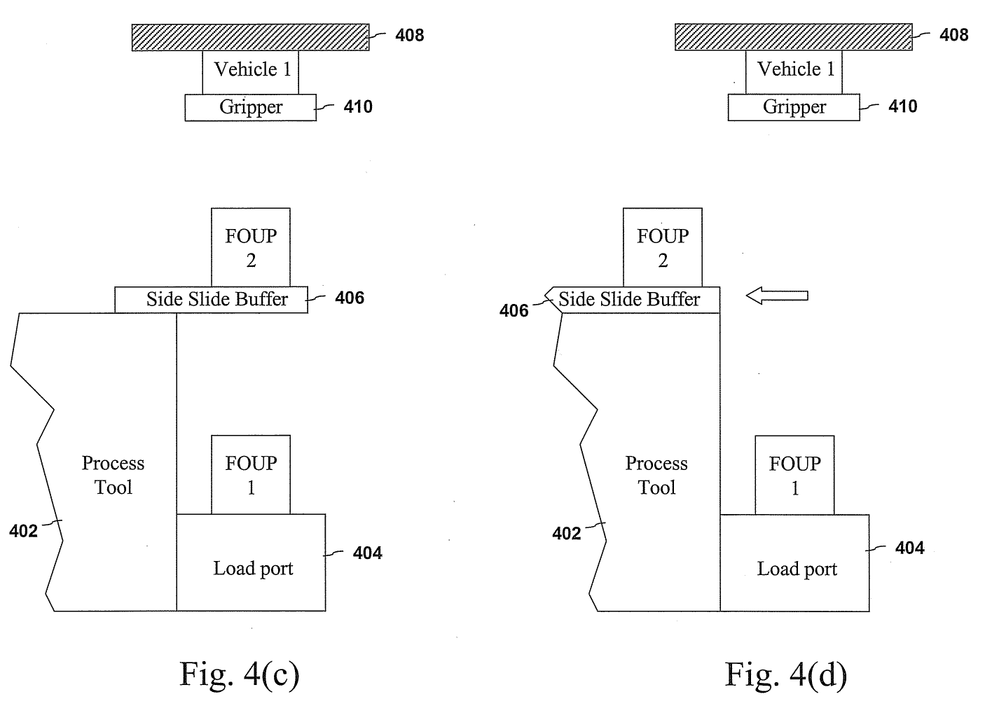

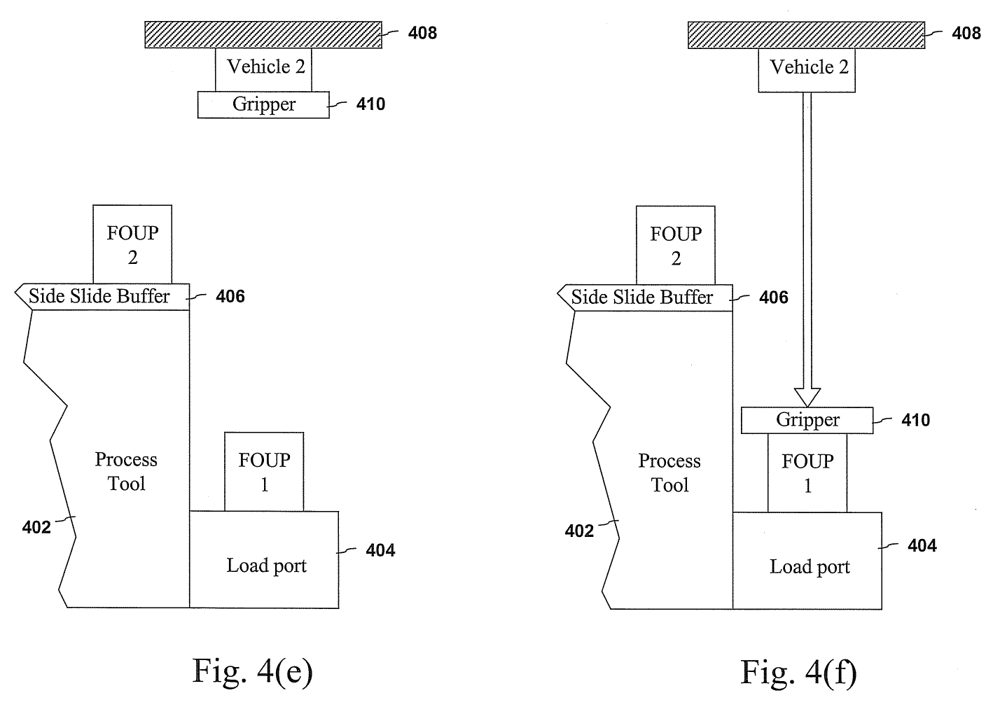

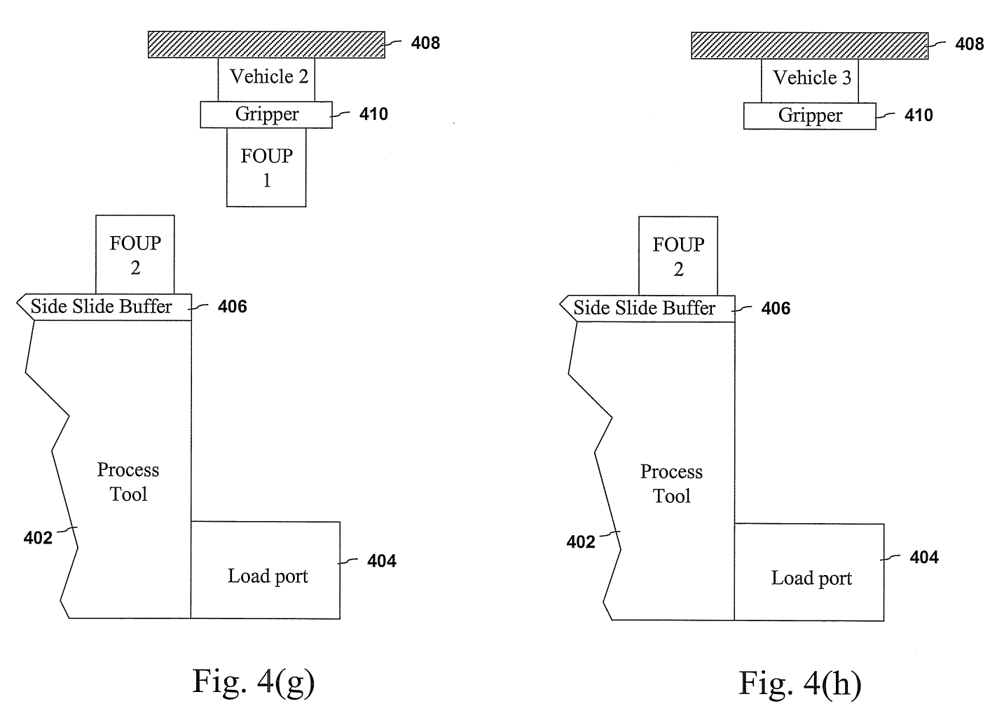

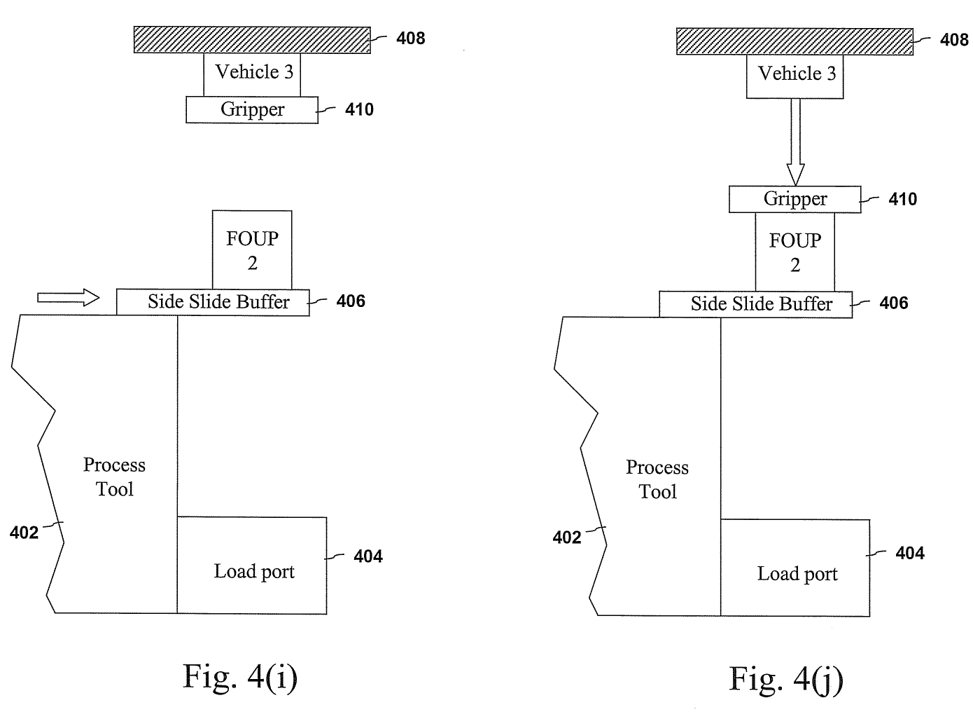

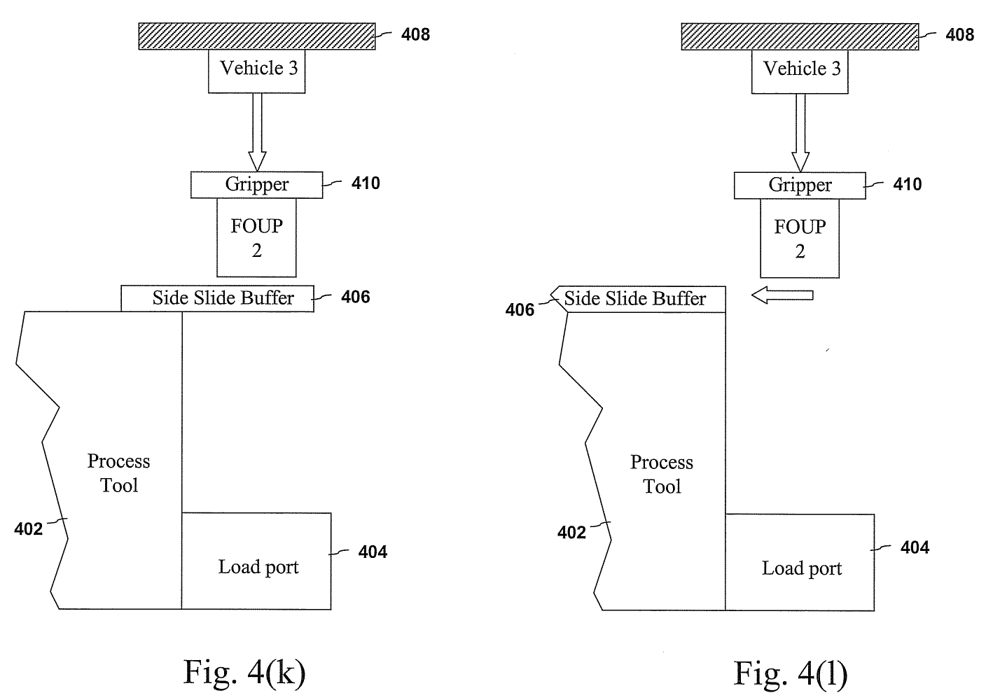

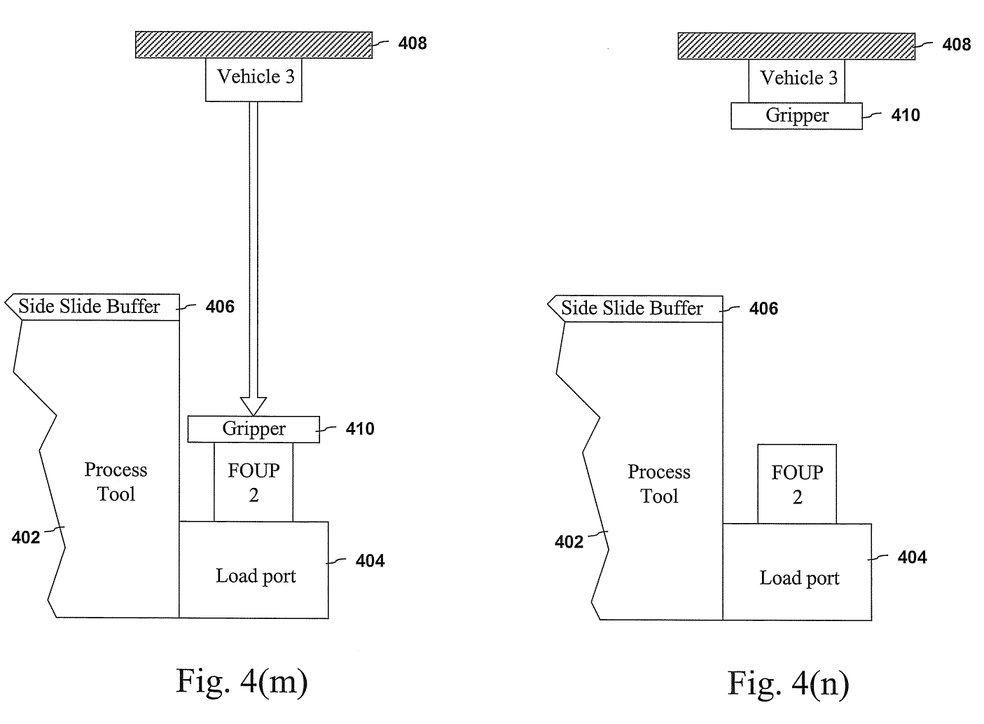

Referring generally now to FIGS. 4(a) through 4(n), there is shown a sequence of schematic diagrams illustrating the operation of a retractable storage buffer system for fabs, in accordance with an embodiment of the invention. In one embodiment, the SSB includes a two-position slide assembly with a product locating nest. The slide assembly is driven (e.g., pneumatically, electrically, etc.) to extended and retracted positions. A product placement sensor may be used to verify whether the buffer is empty or loaded with products (e.g., carriers). Communication handshaking to the OHT for product load/unload may be handled through SEMI (Semiconductor Equipment and Materials International) E84 (Enhanced Carrier Handoff Parallel I/O Interface), similar to that used in existing AMHS facilities.

The SSB may be implemented through a variety of exemplary embodiments, including, but not limited to: integration within the process tool structure, suspended from the ceiling above the tool load ports, supported from the floor on a frame extending across the front end of a process tool, suspended from the ceiling above the dead service space between process tools, and supported from the floor above the dead service space between process tools.

As specifically shown in FIG. 4(a), a process tool 402 and associated load port 404 has a first FOUP (FOUP 1) in process disposed thereon. The unloaded SSB 406 is shown in an extended position above the top of the process tool 402 such that the SSB 406 is directly below the path of an oncoming vehicle (Vehicle 1) of the OHT 408. In the side view depicted, the direction of travel of Vehicle 1 is either into the page or out from the page (i.e., orthogonal to the page of the drawing). Thus, as FOUP 1 is “in process” on the load port 404 of the process tool 402, Vehicle 1 arrives at the tool 402 with FOUP 2. Then, as shown in FIG. 4(b), the hoist (gripper) portion 410 of Vehicle 1 is lowered so as to place FOUP 2 onto the extended SSB 406. Thereafter, the gripper portion 410 is retracted, leaving FOUP 2 stored within the SSB 406, as shown in FIG. 4(c). As shown in FIG. 4(d), the SSB is then brought to a retracted position atop the process tool, thereby providing buffer storage for FOUP 2 in a location proximate the process tool 402, but not within the path of an OHT vehicle or in a location that uses up headroom in the process aisle.

Proceeding now to FIG. 4(e), another OHT vehicle arrives (Vehicle 2) for unloading the process tool 402 at a point in time when processing of the contents of FOUP 1 at tool 402 is complete. In FIG. 4(f), the gripper portion 410 of Vehicle 2 is lowered to engage FOUP 1, and in FIG. 4(g) is hoisted up to Vehicle 2 for transport to another processing location. FOUP 2, still remaining in the retracted SSB 406, is now ready for loading and processing at process tool 402, as signified by the arrival of Vehicle 3 in FIG. 4(h). In FIG. 4(i), the loaded SSB 406 is once again brought to its extended position directly below Vehicle 3. Then, as shown in FIG. 4(j), the gripper portion of Vehicle 3 is lowered to engage FOUP 2 stored in SSB 406. Notably, the extended position of the SSB 406 is such that only simple vertical movement of the OHT vehicle hoist is used to retrieve FOUP 2.

Finally, once the SSB 406 is unloaded (e.g., as detected by a product placement sensor) in FIG. 4(k), the SSB 406 is brought back into the retracted position in FIG. 4(l). This allows Vehicle 3 to load FOUP 2 onto the load port 404 of process tool 402 to begin processing of the contents of FOUP 2 at tool 402, as shown in FIGS. 4(m) and 4(n). Thereafter, additional FOUP(s) may be stored within the SSB 406 to await processing at tool 402. Through the above described retractable buffer system, AMHS product change time is improved, and in a manner compatible with any existing overhead transport system, including the simpler systems that do not provide lateral arm motion. The location of the retractable buffer system is also advantageous, in that it does not physically intrude on process aisles or tool movement paths.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A storage buffer system for an automated material handling system (AMHS), comprising:
a retractable buffer device disposed directly above a processing tool;
the retractable buffer device having an extended position disposed directly below an overhead transport (OHT) vehicle path;
the retractable buffer device further having a retracted position that is removed from a process aisle space, with the retractable buffer device being one of electrically and pneumatically driven to the extended and retracted positions;
one or more limit switches configured to detect the extended and retracted positions of the retractable buffer device; and
one or more product placement sensors configured to detect loading and unloading of the retractable buffer device;
wherein, in the extended position, the retractable buffer device is configured to facilitate loading and unloading of product therein without the use of lateral motion capability of an OHT vehicle.

2.-11. (canceled)

12. A storage buffer system for semiconductor manufacturing facility, comprising:
a retractable buffer device, disposed directly above a load port of a processing tool;
the retractable buffer device having an extended position disposed directly below an overhead transport (OHT) vehicle path;
the retractable buffer device further having a retracted position that is removed from a process aisle space, with the retractable buffer device being one of electrically and pneumatically driven to the extended and retracted positions;
one or more limit switches configured to detect the extended and retracted positions of the retractable buffer device; and
one or more product placement sensors configured to detect loading and unloading of the retractable buffer device;
wherein, in the extended position, the retractable buffer device is configured to facilitate loading and unloading of one or more wafer carriers without the use of lateral motion capability of an OHT vehicle.

13.-17. (canceled)

18. A method of implementing buffer storage in an automated material handling system (AMHS), the method comprising:
moving a retractable buffer device, disposed directly above a processing tool, to an extended position disposed directly below an overhead transport (OHT) vehicle path;
loading the retractable buffer device with a carrier, through vertical motion of a hoist mechanism associated with a first OHT vehicle, and without the use of lateral motion capability of the first OHT vehicle;
moving the retractable buffer to a retracted position that is removed from a process aisle space;
moving the retractable buffer device, containing the carrier stored therein, to the extended position;
unloading the retractable buffer device, through vertical motion of a hoist mechanism associated with a second OHT vehicle, and without the use of lateral motion capability of the second OHT vehicle;
moving the retractable buffer device back to the retracted position; and
lowering the carrier to a load port of the processing tool, using the hoist mechanism associated with the second OHT vehicle.

19.-20. (canceled)
